(19) United States
(12) Patent Application Publication
(10) Pub. No.: US 2014/0213354 A1
(43) Pub. Date: Jul. 31, 2014

(54) ELECTRONIC DEVICE AND HUMAN-COMPUTER INTERACTION METHOD

(71) Applicant: Hon Hai Precision Industry Co., Ltd., New Taipei (TW)

(72) Inventor: YI-AN CHEN, New Taipei (TW)

(73) Assignee: HON HAI PRECISION INDUSTRY CO., LTD., New Taipei (TW)

(21) Appl. No.: 14/159,683

(22) Filed: Jan. 21, 2014

(30) Foreign Application Priority Data
Jan. 30, 2013 (TW) 102103395

(51) Int. Cl. A63F 13/20

(52) U.S. Cl. CPC A63F 13/06
USPC 463/31

(57) ABSTRACT

An electronic device includes a base member and a display member rotatably coupled to the base member. A keyboard and a touchpad are located on a working surface of the base member. The touchpad defines a middle touch area, a left touch area, and a right touch area. The middle touch area is configured for simulating a mouse. The first and second touch areas are configured for simulating a gaming controller. A human-computer interaction method is also provided.

### REFERENCE TO RELATED APPLICATIONS

This application claims all benefits accruing under 35 U.S.C. §119 from Taiwan Patent Application No. 102103395, filed on Jan. 30, 2013 in the Taiwan Intellectual Property Office. The contents of the Taiwan Application are hereby incorporated by reference. In addition, subject matter relevant to this application is disclosed in: co-pending U.S. Patent Application entitled “ELECTRONIC DEVICE,” Attorney Docket Number US51048, Application No. [to be advised], filed on the same day as the present application. This application and the co-pending U.S. Patent Application are commonly owned, and the contents of the co-pending U.S. Patent Applications are hereby incorporated by reference.

### BACKGROUND

1. Technical Field

The disclosure generally relates to electronic devices, and particularly relates to electronic devices having a touchpad and human-computer interaction methods.

2. Description of Related Art

Many notebook computers use touchpads as a “cursor navigator” as well as a component for selecting functions such as “select” and “confirm”. However, the touchpads are often small and incapable of recognizing more complex touch operations.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an embodiment of an electronic device.

FIG. 2 is a schematic view of a base member of the electronic device of FIG. 1.

FIG. 3 is a schematic view of a touchpad simulating a gamepad.

FIG. 4 is a schematic view of a touchpad simulating a joystick.

FIG. 5 is a schematic view of a touchpad simulating a steering wheel.

FIG. 6 is a flowchart of an embodiment of a human-computer interaction method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

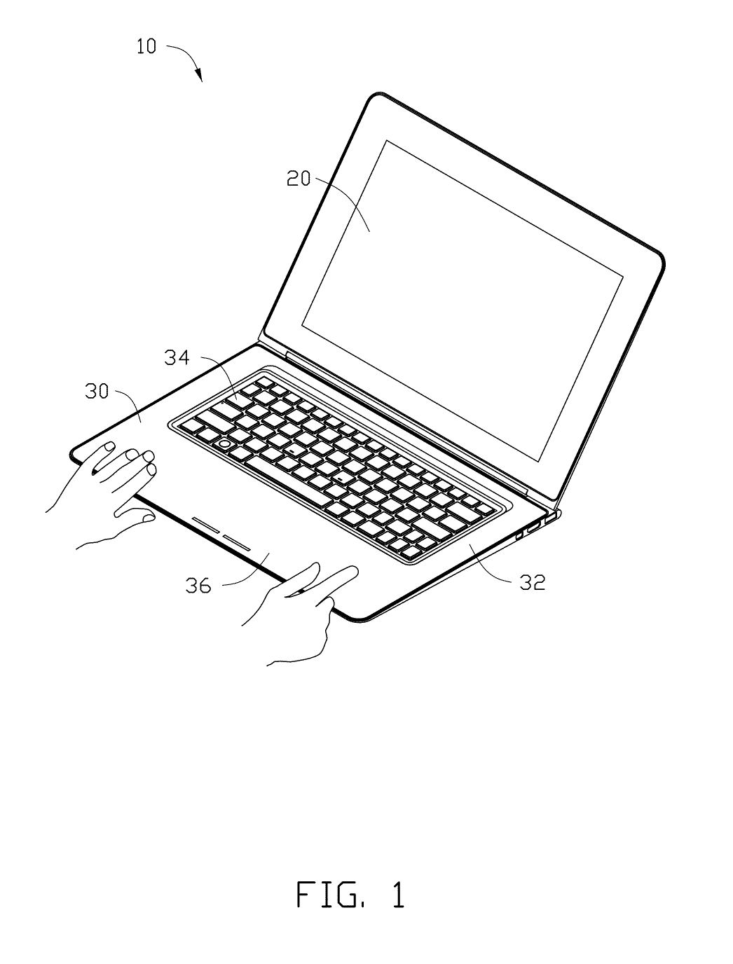

FIG. 1 is a block diagram of an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

In one embodiment, the electronic device 10 includes a display member 20 rotatably coupled to a base member 30 to enable variable positioning of the display member 10 relative to the base member 30. A keyboard 34 and a touchpad 36 are located on a working surface 32 of the base member 30. In the illustrated embodiment, the touchpad 36 is located in front of the keyboard 34.

In one embodiment, a length of the touchpad 36 is greater than 18 centimeters (cm), so that the touchpad 36 is suitable for two-hand operation by a user of the electronic device 10. The length of the touchpad 36 is substantially the same as the length of the keyboard 34. In other embodiments, the length of the touchpad 36 is substantially the same as the length of the base member 30.

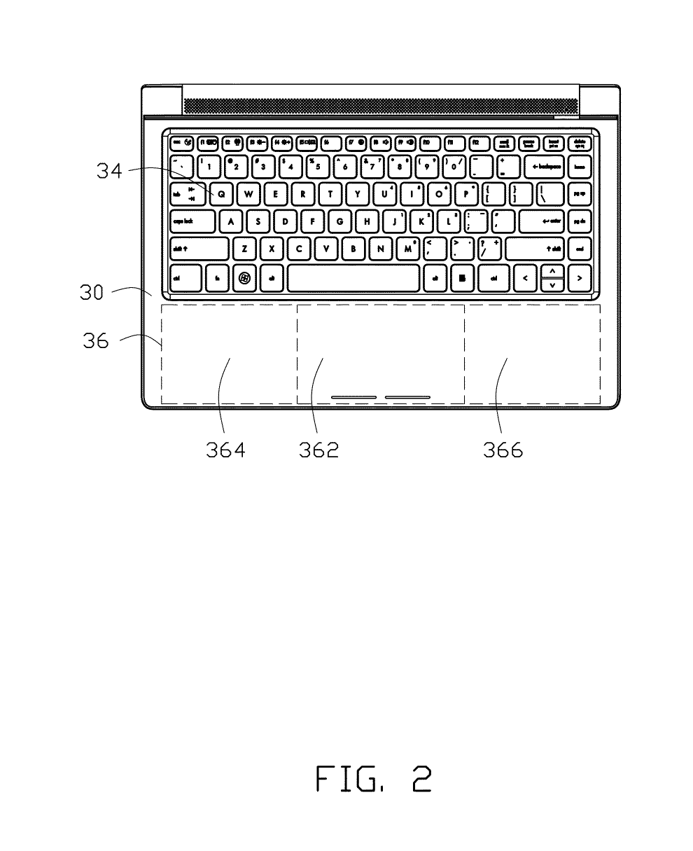

Referring to FIG. 2, the touchpad 36 defines a middle touch area 362, a left touch area 364, and a right touch area 366. The left touch area 364 is located on a left side of the middle touch area 362, and the right touch area 366 is located on a right side of the middle touch area 362. In one embodiment, the left touch area 364 and the right touch area 366 are seamlessly connected to the middle touch area 362.

The middle touch area 362 may simulate a pointing device such as a mouse. The left touch area 364 and the right touch area 366 may simulate a gaming controller. The gaming controller may be a gamepad, a joystick, or a steering wheel.

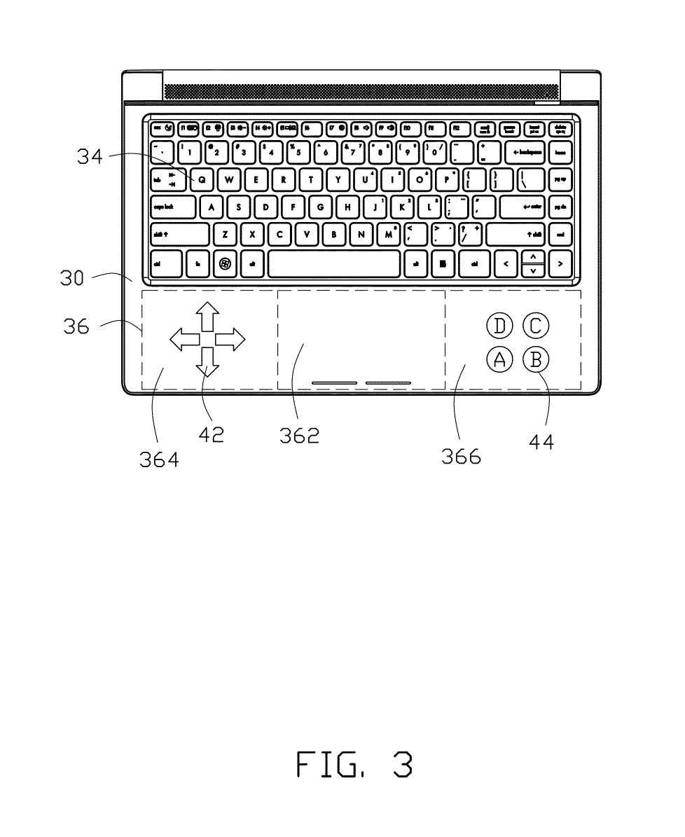

As illustrated in FIG. 3, the left touch area 364 and the right touch area 366 simulate a gamepad. The gamepad includes a plurality of direction keys 42 and a plurality of function keys 44. The left touch area 364 simulates the direction keys 42. The right touch area 366 simulates the function keys 44. In the embodiment illustrated in FIG. 3, the gamepad includes four direction keys 42 and four function keys 44. In some embodiments, the gamepad may include eight or more direction keys 42 and six or more function keys 44.

In another embodiment, the left touch area 364 may simulate the function keys 44 and the right touch area 366 may simulate the direction keys 42.

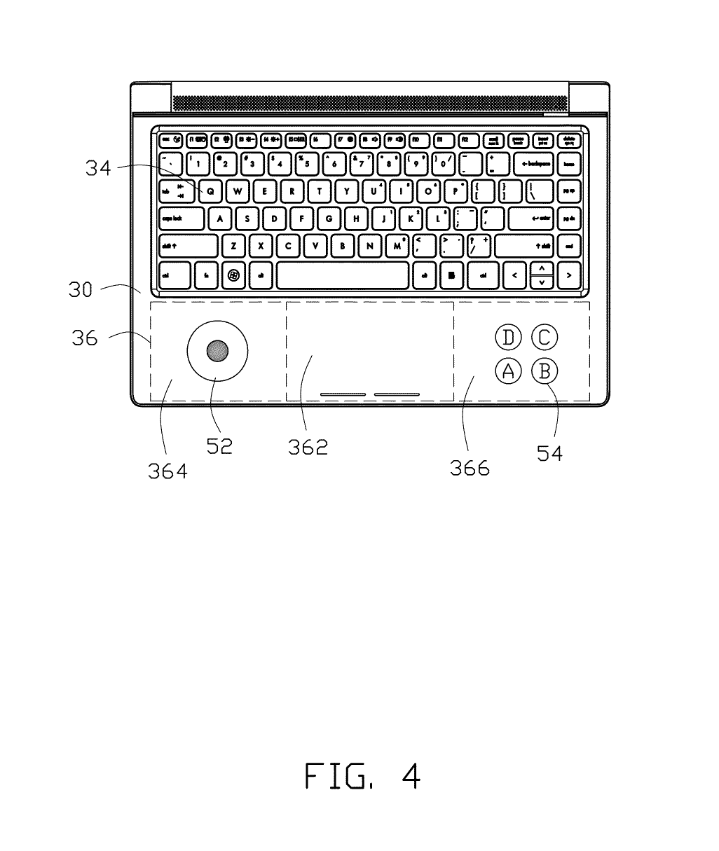

As illustrated in FIG. 4, the left touch area 364 and the right touch area 366 simulate a joystick. The joystick includes an analogue stick 52 and a plurality of function keys 54. The left touch area 364 simulates the analogue stick 52. The right touch area 366 simulates the function keys 54. In the embodiment illustrated in FIG. 4, the joystick includes four function keys 54. In some embodiments, the joystick may include six or more function keys 54.

In another embodiment, the left touch area 364 may simulate the function keys 54 and the right touch area 366 may simulate the analogue stick 52.

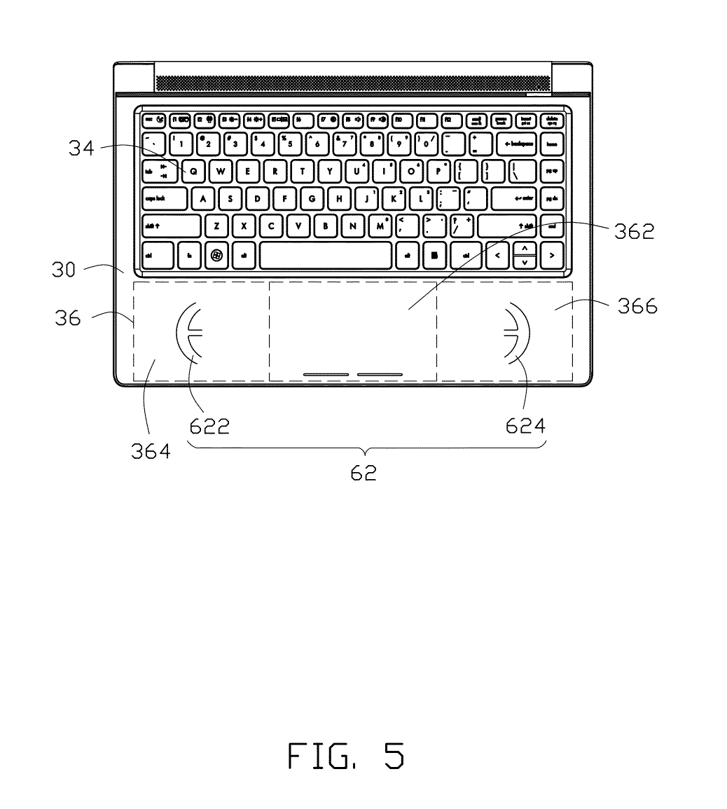

As illustrated in FIG. 5, the left touch area 364 and the right touch area 366 simulate a steering wheel 62. The steering wheel 62 includes a left portion 622 and a right portion 624. The left touch area 364 simulates the left portion 622 of the steering wheel 62. The right touch area 366 simulates the right portion 624 of the steering wheel 62.

In one embodiment, when only one of the left touch area 364 and the right touch area 366 detects a touch gesture with more than a pre-determined number of touch points such as 2500 touch points, the left touch area 364 and the right touch area 366 simulate a joystick. When none of the left touch area 364 and the right touch area 366 detects a touch gesture with more than the pre-determined number of touch points, the left touch area 364 and the right touch area 366 simulate a gamepad. When the left touch area 364 and the right touch area 366 simultaneously detect a touch gesture with more than the pre-determined number of touch points, the left touch area 364 and the right touch area 366 simulate a steering wheel.

The electronic device 10 may provide a user interface (UI) to allow the user to customize the gaming controller simulated by the left touch area 364 and the right touch area 366. For example, the user may add, delete, or relocate an element of the gaming controller via the UI.

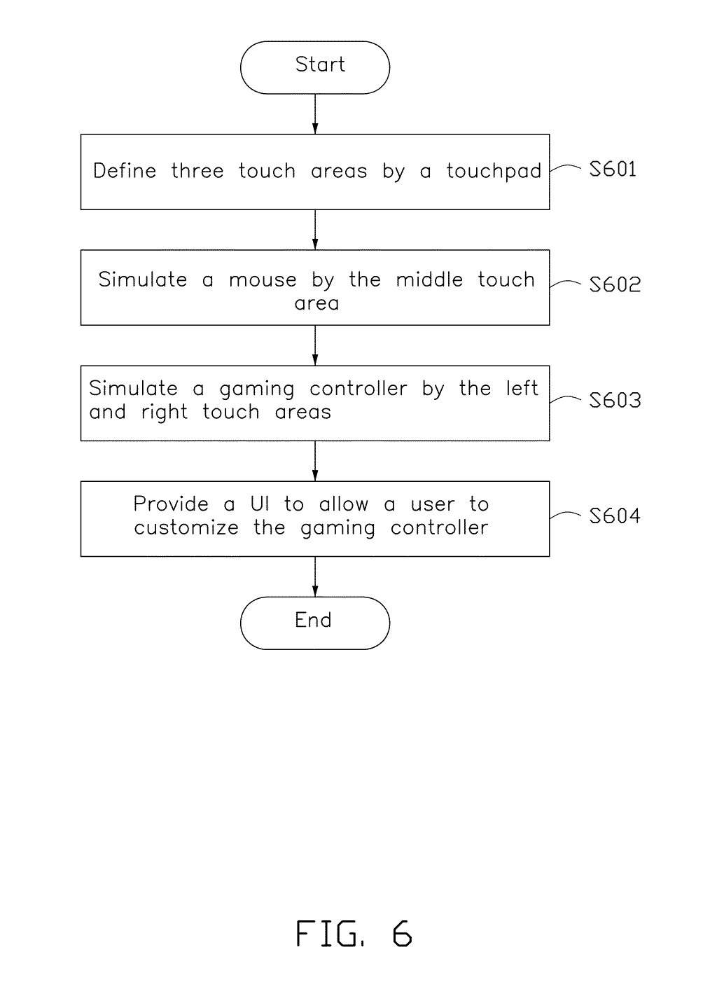

FIG. 6 shows a flowchart of one embodiment of a human-computer interaction method. The method includes the following steps.

In step S601, the touchpad 36 defines a middle touch area 362, a left touch area 364, and a right touch area 366. The left touch area 364 is located on a left side of the middle touch area 362, and the right touch area 366 is located on a right side of the middle touch area 362. In one embodiment, the left touch area 364 and the right touch area 366 are seamlessly connected to the middle touch area 362.

In step S602, the middle touch area 362 simulates a mouse.

In step S603, the left touch area 364 and the right touch area 366 simulate a gaming controller.

In step S604, the electronic device 10 provides a UI to allow the user to customize the gaming controller simulated by the left touch area 364 and the right touch area 366.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. An electronic device, comprising:
a base member;
a display member rotatably coupled to the base member; and
a keyboard and a touchpad located on a working surface of the base member; the touchpad defining a middle touch area, a first touch area, and a second touch area; the first touch area and the second touch area being located on two sides of the middle touch area;
wherein the middle touch area is configured for simulating a mouse, and the first and second touch areas are configured for simulating a gaming controller.

2. The electronic device of claim 1, wherein the first and second touch areas are seamlessly connected to the middle touch area.

3. The electronic device of claim 2, wherein the gaming controller comprises a plurality of direction keys and a plurality of function keys, the first touch area is configured for simulating the plurality of direction keys, and the second touch area is configured for simulating the plurality of function keys.

4. The electronic device of claim 2, wherein the gaming controller comprises an analogue stick and a plurality of function keys, the first touch area is configured for simulating the analogue stick, and the second touch area is configured for simulating the plurality of function keys.

5. The electronic device of claim 2, wherein the gaming controller comprises a steering wheel, the first touch area is configured for simulating a left portion of the steering wheel, and the second touch area is configured for simulating a right portion of the steering wheel.

6. The electronic device of claim 2, wherein the touchpad is suitable for two-hand operation by a user of the electronic device.

7. The electronic device of claim 2, wherein a length of the touchpad is substantially the same as a length of the keyboard.

8. The electronic device of claim 2, wherein a length of the touchpad is substantially the same as a length of the base member.

9. The electronic device of claim 2, wherein when only one of the first and second touch areas detects a touch gesture with more than a pre-determined number of touch points, the first and second touch areas are configured for simulating a joystick-type gaming controller.

10. The electronic device of claim 2, wherein when the first and second touch areas simultaneously detect a touch gesture with more than a pre-determined number of touch points, the first and second touch areas are configured for simulating a steering-wheel-type gaming controller.

11. A human-computer interaction method implemented in an electronic device, the electronic device comprising a base member, a display member rotatably coupled to the base member, a keyboard and a touchpad located on a working surface of the base member, the human-computer interaction method comprising:
defining a middle touch area, a first touch area, and a second touch area by the touchpad; the first touch area and the second touch area being located on two sides of the middle touch area;
simulating a mouse by the middle touch area; and
simulating a gaming controller by the first and second touch areas.

12. The human-computer interaction method of claim 11, wherein the first and second touch areas are seamlessly connected to the middle touch area.

13. The human-computer interaction method of claim 12, wherein the gaming controller comprises a plurality of direction keys and a plurality of function keys, the simulating the gaming controller comprising:
simulating the plurality of direction keys by the first touch area; and
simulating the plurality of function keys by the second touch area.

14. The human-computer interaction method of claim 12, wherein the gaming controller comprises an analogue stick and a plurality of function keys, the simulating the gaming controller comprising:
simulating the analogue stick by the first touch area; and
simulating the plurality of function keys by the second touch area.

15. The human-computer interaction method of claim 12, wherein the gaming controller comprises a steering wheel, the simulating the gaming controller comprising:
simulating a left portion of the steering wheel by the first touch area; and
simulating a right portion of the steering wheel by the second touch area.

16. The human-computer interaction method of claim 12, wherein the touchpad is suitable for two-hand operation by a user of the electronic device.

17. The human-computer interaction method of claim 12, wherein a length of the touchpad is substantially the same as a length of the keyboard.

18. The human-computer interaction method of claim 12, wherein a length of the touchpad is substantially the same as a length of the base member.

19. The human-computer interaction method of claim 12, further comprising:
when only one of the first and second touch areas detects a touch gesture with more than a pre-determined number of touch points, simulating a joystick-type gaming controller by the first and second touch areas.

20. The human-computer interaction method of claim 12, further comprising:
when the first and second touch areas simultaneously detect a touch gesture with more than a pre-determined number of touch points, simulating a steering-wheel-type gaming controller by the first and second touch areas.
